(19) United States
(12) Patent Application Publication
(10) Pub. No.: US 2026/0333144 A1
(43) Pub. Date: Oct. 22, 2026

(54) CELL RE-SELECTION FOR ATG

(71) Applicant: Apple Inc., Cupertino, CA (US)

(72) Inventors: Qiming Li, Beijing (CN); Yang Tang, San Jose, CA (US); Dawei Zhang, Saratoga, CA (US); Jie Cui, San Jose, CA (US); Manasa Raghavan, Sunnyvale, CA (US); Xiang Chen, Campbell, CA (US); Yuexia Song, Beijing (CN); Rolando E. Bettancourt Ortega, Munich (DE)

(73) Assignee: Apple Inc., Cupertino, CA (US)

(21) Appl. No.: 19/111,306

(22) PCT Filed: Sep. 29, 2022
(86) PCT No.: PCT/CN2022/122875

§ 371 Date: Mar. 12, 2025

(51) Int. Cl. H04W 36/00; H04B 7/185; H04W 36/32

(52) U.S. Cl. CPC H04W 36/0061; H04B 7/18504; H04B 7/18506; H04W 36/0058; H04W 36/00835; H04W 36/324; H04W 36/328

(57) ABSTRACT

Provided is a method for a user equipment (UE). The UE performs at least one of the followings: obtaining a first information from a BS indicating at least one candidate cell, the first information being based on a flight trajectory associated with the UE; obtaining a second information from a BS indicating an accessibility of a cell, the second information being based on at least one of following: whether the cell is related to an ATG dedicated BS or a TN BS, a coverage of the cell, or a geographic location of the cell; obtaining a third information indicating a power mode switching operation from a BS, the third information being based on at least one of the following: a cell radius of a serving cell, a cell radius of at least one neighbor cell, a geographic location of the serving cell, or a geographic location of the at least one neighbor cell; or generating a fourth information relating to a flying status of the UE for transmitting to a BS, the fourth information being used for the BS to determine at least one parameter for UE measurement reporting.

### TECHNICAL FIELD

This application relates generally to wireless communication systems, and more specifically to cell re-selection for Air-To-Ground (ATG).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, provided is a method for a user equipment (UE), the method comprising: performing at least one of: obtaining, from a base station (BS), a first information indicating at least one candidate cell, the first information being based on a flight trajectory associated with the UE, obtaining, from a BS, a second information indicating an accessibility of a cell, the second information being based on at least one of following: whether the cell is related to an Air-To-Ground (ATG) dedicated BS or a terrestrial network (TN) BS, a coverage of the cell, or a geographic location of the cell, obtaining, from a BS, a third information indicating a power mode switching operation, the third information being based on at least one of the following: a cell radius of a serving cell, a cell radius of at least one neighbor cell, a geographic location of the serving cell, or a geographic location of the at least one neighbor cell, or generating, based on a flying status of the UE and for a BS to determine at least one parameter for UE measurement reporting, a fourth information for transmitting to the BS.

According to an aspect of the present disclosure, provided is a method for a base station (BS), the method comprising performing at least one of: generating, based on a flight trajectory associated with a user equipment (UE), a first information for transmitting to the UE, the first information indicating at least one candidate cell for the UE, generating a second information for transmitting to a UE based on at least one of following: whether a cell is related to an Air-To-Ground (ATG) dedicated BS or a terrestrial network (TN) BS, a coverage of the cell, or a geographic location of the cell, the second information indicating accessibility for the UE to the cell, generating a third information for transmitting to a UE based on at least one of the following: a cell radius of a serving cell, a cell radius of at least one neighbor cell, a geographic location of the serving cell, or a geographic location of the at least one neighbor cell, the third information indicating a power mode switching operation for the UE, or obtaining a fourth information relating to a flying status of a UE from the UE, and determining, based on the fourth information, at least one parameter for UE measurement reporting.

According to an aspect of the present disclosure, provided is an apparatus for a user equipment (UE), the apparatus comprising: one or more processors configured to perform steps of the method according to the present disclosure.

According to an aspect of the present disclosure, provided is an apparatus for a base station (BS), the apparatus comprising: one or more processors configured to perform steps of the method according to the present disclosure.

According to an aspect of the present disclosure, provided is an apparatus for a user equipment (UE), comprising means for performing steps of the method according to the present disclosure.

According to an aspect of the present disclosure, provided is an apparatus for a base station (BS), comprising means for performing steps of the method according to the present disclosure.

According to an aspect of the present disclosure, provided is a computer readable medium having computer programs stored thereon which, when executed by one or more processors, cause an apparatus to perform steps of the method according to the present disclosure.

According to an aspect of the present disclosure, provided is a computer program product comprising computer programs which, when executed by one or more processors, cause an apparatus to perform steps of the method according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a user equipment in accordance with some embodiments.

FIG. 3 illustrates a flowchart for an exemplary method for a network device in accordance with some embodiments.

FIG. 4 illustrates an exemplary block diagram of an apparatus for a UE in accordance with some embodiments.

FIG. 5 illustrates an exemplary block diagram of an apparatus for a network device in accordance with some embodiments.

FIG. 6 illustrates example components of a device in accordance with some embodiments.

FIG. 7 illustrates example interfaces of baseband circuitry in accordance with some embodiments.

FIG. 8 illustrates components in accordance with some embodiments.

FIG. 9 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, Air-To-Ground (ATG) operation has been developed. For in 3GPP R18 (latest WID in RP #96: RP-221369), features are specified to core specifications for ATG BS and UE. Scenarios include, e.g., BS on the ground, and the CPE type of UE mounted in the aircraft and/or a direct radio link between BS on the ground and CPE type of UE mounted in the aircraft. During ATG scenarios, cell re-selection may occur more frequently than legacy case, and thus solutions or enhancement to cell re-selection procedure for ATG may be needed.

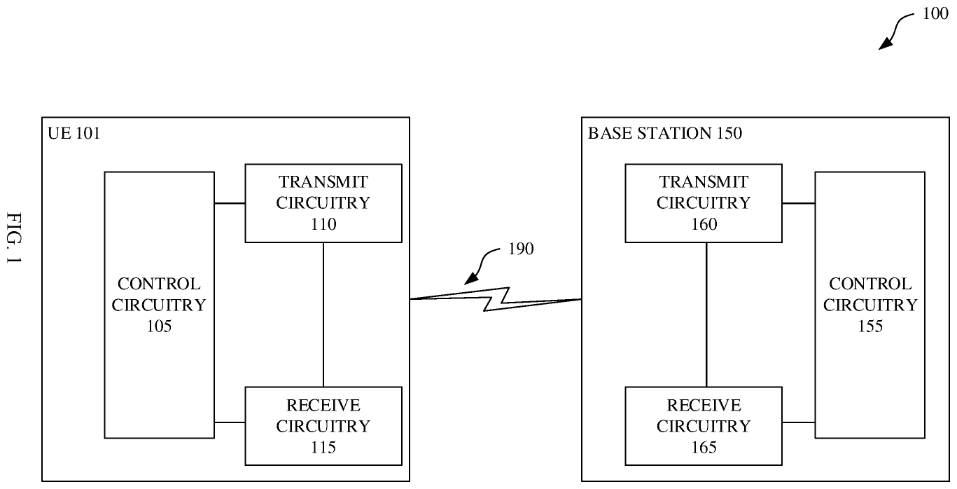

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and the network device described in the following embodiments may be implemented by the UE 101 and the base station 150 described in FIG. 1.

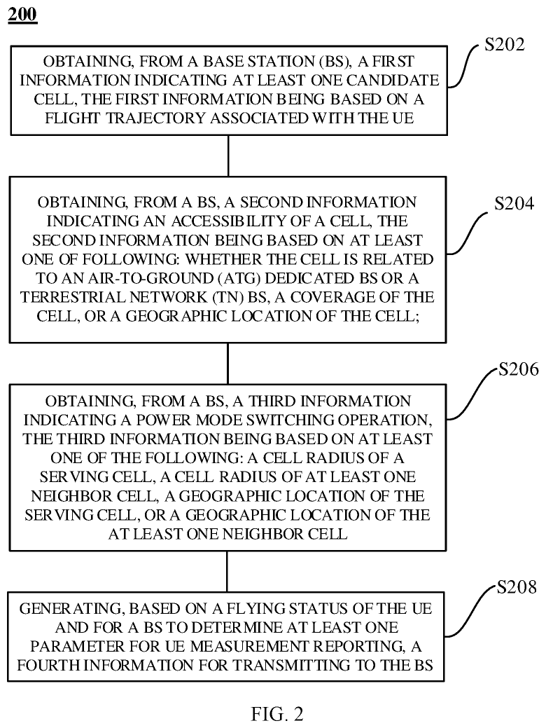

FIG. 2 illustrates a flowchart for an exemplary method for a user equipment in accordance with some embodiments. The method 200 illustrated in FIG. 2 may be implemented by the UE 101 described in FIG. 1.

In some embodiments, the method 200 for UE may include at least one of the following steps: S202, obtaining, from a base station (BS), a first information indicating at least one candidate cell, the first information being based on a flight trajectory associated with the UE; S204, obtaining, from a BS, a second information indicating an accessibility of a cell, the second information being based on at least one of following: whether the cell is related to an Air-To-Ground (ATG) dedicated BS or a terrestrial network (TN) BS, a coverage of the cell, or a geographic location of the cell; S206, obtaining, from a BS, a third information indicating a power mode switching operation, the third information being based on at least one of the following: a cell radius of a serving cell, a cell radius of at least one neighbor cell, a geographic location of the serving cell, or a geographic location of the at least one neighbor cell; and/or S208, generating, based on a flying status of the UE and for a BS to determine at least one parameter for UE measurement reporting, a fourth information for transmitting to the BS.

According to some embodiments of the present disclosure, cell re-selection procedure can be enhanced for ATG operation.

In the following, each step of the method 200 will be described in details.

At step S202, a first information indicating at least one candidate cell is obtained from a base station (BS), the first information being based on a flight trajectory associated with the UE.

According to some embodiments, network assistance information of neighbor cell can be provided to the UE.

In some embodiments, the first information includes a Physical Cell Identifier (PCI) list based on the flight trajectory, and the method further including searching and measuring at least one neighbor cell in the PCI list. Such embodiments alleviate the need to search for all the candidate PCI, and thus latency can be reduced and power saving can be achieved.

In some embodiments, the first information further includes at least one geographic position for the at least one neighbor cell, and the method further including determining a start cell searching time based on the at least one geographic position and a location of the UE. In such embodiments, the ATG UE would have the knowledge on when to start cell searching and for which target cell to search.

According to some embodiments, a mechanism facilitating cell re-selection procedure for ATG can be provided. In some examples, a serving cell base station such as a gNB may broadcast the PCI list based on the flight trajectory. This is because flight trajectory is often pre-defined and stable. Therefore, an ATG UE only needs to search and measure the neighbor cell(s) in the PCI list. In the contrary, legacy UE needs to search for all the candidate PCI. Therefore, latency can be reduced and power saving can be achieved.

Additionally, network can also broadcast the gNB geographic position. Since an ATG UE may know its location precisely due to GNSS, with the gNB position information, the ATG UE knows when to start cell searching and for which target cell to search, for candidate cell re-selection. in this example, latency can be further reduced and power saving can be further achieved.

At step S204, a second information indicating an accessibility of a cell is obtained from a base station (BS), the second information being based on at least one of following: whether the cell is related to an Air-To-Ground (ATG) dedicated BS or a terrestrial network (TN) BS, a coverage of the cell, or a geographic location of the cell.

According to some embodiments, ATG UE access control can be achieved.

In some scenarios, along the flight trajectory, the ATG UE can see not only the ATG dedicated BS, but also regular terrestrial network (TN) BS. If the TN BS has good coverage, e.g., in rural area near the airport wherein the plane is not moving that fast (hasn't reach it cruising speed), it can serve the ATG UE. If the TN BS doesn't have extensive coverage, e.g., in urban area, it is not suitable to serve the ATG UE.

For example, a flag may be introduced in system information 1 or 2, as the second information, to indicate whether the ATG UE is allowed to access or camp on.

In some embodiments, the second information includes a first indicator indicating whether the cell is suitable for ATG service, and the method further including: in response to determining that the UE is flying and that the cell is indicated in the first indicator as not suitable for ATG service, determining not to access or camp on the cell.

For example, the flag can be a Boolean parameter. In such cases, the UE may determine whether it operates as an ATG UE (i.e., whether it is flying) based on its speed, height, location, and so on. Then, the UE may know whether it is allowed to access or camp on the cell indicated by the second information.

In some embodiments, the second information includes a first threshold for the cell, the first threshold including at least one threshold selected from a group consisting of a speed threshold and a height threshold, and the method further including: in response to determining that the first threshold is exceeded for the UE, determining not to access or camp on the cell.

For example, the flag, as the second information, can also be a threshold of speed. The method can include, e.g., obtaining a current status of the UE, the obtained current status indicating at least one of a moving speed or a height of the UE. When the ATG UE is moving with speed above the threshold, it is not allowed to access or camp on the cell. Otherwise, e.g., when the plane is still on the ground, it is allowed to access or camp on the cell.

According to some embodiments, flexibility can be achieved. For example, some of the embodiments allow an aircraft-mounted UE, in a case that it is not flying/moving fast, to utilize some regular TN BS. For another example, for an ATG UE, a rural BS with larger coverage may be more suitable than an urban BS with smaller coverage, and it may be beneficial to indicate to UE that whether a certain BS is allowed to access and/or a certain BS is allowed to access below a threshold moving speed, height, etc. Therefore, communication resources of different type can be effectively unitized and better communication quality may be achieved.

At step S206, a third information indicating a power mode switching operation is obtained from a base station (BS), the third information being based on at least one of the following: a cell radius of a serving cell, a cell radius of at least one neighbor cell, a geographic location of the serving cell, or a geographic location of the at least one neighbor cell.

According some embodiments, high/low power consumption mode related to ATG operation an also be achieved. Increasing cell search and measurement activity can facilitate cell re-selection procedure yet increase power consumption. Therefore, it is important to balance the power consumption and cell re-selection performance.

In some embodiments, the power mode switching operation includes to enter or to quit a specific power mode, the specific power mode including at least one of a high power mode or a low power mode. For instance, while flying within a relatively small cell (e.g., a TN gNB), or at cell edge, more frequent cell search and measurement activity may be needed, and the ATG UE may need to enter high power consumption mode (HPM). While flying within a huge cell, or not at cell edge, less frequent cell search and measurement activity may be needed, and the ATG UE may choose to quit HPM. When staying on the ground, the ATG UE may even enter low power consumption mode (LPM). Therefore, by transmitting a third information based on a cell radius and/or a geographic location of a serving cell or a neighbor cell(s), power mode can be chosen more effectively.

In some embodiments, the power mode switching may be under network's control. For example, a new flag can be introduced, as the third information, from NW to UE to indicate whether UE shall enter HPM. When to indicate the new flag may be up to NW implementation, e.g., based on cell radius, geographic location and etc.

In some examples, the third information includes a second indicator indicating the UE to enter or quit the specific power mode. For example, the new flag can be a Boolean parameter captured in system information (SIBx) or a dedicated RRC configuration, and the disclosure is not limited thereto.

Additionally or alternatively, the third information includes a second threshold including at least one speed threshold, at least one height threshold, or both, and the method further including determining to enter or quit the specific power mode upon satisfying the second threshold. For example, the new flag can also be a speed threshold. When the ATG UE is moving with speed above the threshold, it shall enter HPM. Otherwise, it is allowed to quit HPM.

It can be seen that, although descriptions are made regarding HPM, it also applies for low power mode (LPM). For example, another flag can be introduced to control when UE shall enter/quit LPM, with similar design as that for HPM. As an unlimiting example, the third information may include a speed and/or height threshold for HPM, and another a speed and/or height threshold for LPM, when the UE status exceeds the former, the HPM shall be entered, and when the UE falls below the latter, the LPM shall be entered. As another unlimiting example, the third information may include some more thresholds, e.g., four thresholds, for entering HPM, quitting HPM, quitting LPM, entering LPM, respectively, and it can be seen that the disclosure is not limited thereto.

In some additional or alternative examples, the power consumption mode switching related to ATG can be under UE's control. In some examples, the third information includes at least one of the following: a cell radius of a serving cell, at least one cell radius of at least one neighbor cell, a geographic location of the serving cell, or at least one geographic location of the at least one neighbor cell, and the method further including determining to enter or quit the specific power mode based on the third information and at least one of the following: a moving speed, a height, or a location of the UE.

In such examples, NW informs UE about cell radius, or geographic position of serving and neighbor cell(s), or BS type (TN gNB or dedicated ATG gNB). The ATG UE can determine when to enter/quit the HPM/LPM, e.g., based on the information provided by NW and its own location, speed and etc.

At step S208, a fourth information for transmitting to the BS is generated based on a flying status of the UE and for a BS to determine at least one parameter for UE measurement reporting.

So far handover in NR is triggered (directly or indirectly) by NW. Typically, NW configures measurement and corresponding reporting event like A3 (signal level of neighbor cell is X dB higher than that of serving cell). UE keeps measuring neighbor cell(s). Once the condition in the reporting event is met, UE triggers measurement report. After receiving the report, NW triggers handover accordingly.

When the plane is flying toward next gNB with high speed, the measurement result of target cell may get stronger quickly. NW may need to trigger handover timely, e.g., by configuring smaller A3 threshold, shorter time-to-trigger (TTT) window and so on. By contrast, when the plane is flying with relatively low speed, or even on the ground, NW may want to configure all parameters as legacy since smaller A3 threshold and shorter TTT window may lead to Ping-Pong Handover (HO), which is undesirable especially when the plane is still on the ground.

According to some embodiments, a flag from UE to a network device such as a BS or a gNB can be introduced, as the fourth information, to indicate whether the ATG UE is in flying mode.

In some embodiments, the fourth information includes at least one of the following: a third indicator indicating whether the UE is flying; a moving speed of the UE; or an enumerated parameter indicating the moving speed of the UE.

In some examples, the fourth information indicating a flying mode can be a new Boolean parameter. In some other examples, the fourth information can also include the speed of the UE, e.g., a speed value, or an enumerated parameter which includes, e.g., low, medium and high.

In 3GPP R18, also specified are core requirements for coexistence between ATG and IMT terrestrial network. Example bands include n1, n78 and n79. FR1 co-existence evaluation can be performed for ATG network (e.g., ACLR, ACS). Key characteristics are identified where it is necessary to differentiate ATG ground-based BS and UEs from conventional ground-based BS and UEs. One aim is to reuse existing requirements for BS and UE where possible, e.g., to reuse TN BS requirements for ATG BS. Also specified are RF requirements for ATG UE/BS, including considering the results of co-existence simulations in terms of impact on emissions and RX requirements, cell sizes and link budgets, technology capabilities, likely BS and UE architectures and other relevant aspects, taking into account identified differences between ATG and fully ground based systems, considering BS type 1-C/1-H/1-O and specify the requirements and/or considering conductive requirements for UE. Also specify are RRM core requirements for ATG UE, including, e.g., taking into account identified differences between ATG and fully ground based systems, and/or considering the different nature of ATG UEs and their view of the network, increased cell sizes and other relevant aspects. Also specified are new UE/BS type(s) for ATG network, if necessary.

In some existing ATG operation scenarios, the flight speed can be up to 1200 km/h. Cell re-selection may occur more frequently than legacy case. Therefore, existing cell re-selection model may not be applicability especially when cell coverage is not large enough.

According to some embodiments of the disclosure, by introducing at least one of a first information of network assistance information of neighbor cell, a second information for ATG UE access control, a third information of power consumption mode selection based on UE flying status, UE location related to a cell and/or cell coverage for transmitting to a UE, UE can be more aware of the ATG status. Therefore, the latency of cell searching, measuring, handover, etc., can be reduced. On the other hand, since unnecessary cell searching can be avoided due to the new knowledge introduced by the first, second, and/or third information, UE may know when to search and/or when to turn into a power-saving mode, unnecessary power consumption will be greatly reduced. It can be understood that first, second, and/or third information can be introduced by broadcasting, and in some cases, at least a part of the first, second, and/or third information can also be pre-defined or pre-configured.

According to some embodiments of the disclosure, by introducing a fourth information for UE reporting flying mode and non-flying mode, the NW would know the UE status regarding to ATG operation, and would adjust some UE measurement parameters accordingly. For example, a smaller A3 threshold and shorter TTT window can be set when the UE is flying, since an ATG UE usually moves alone a flight trajectory, and chances of Ping-Pong HO are relatively low. Therefore, more effective handover can be achieved. It can be understood that the fourth information can be transmitted by RRC, DCI, MAC CE, and so on, and the disclosure is not limited thereto.

It also can be understood that any number of the first, second, third, fourth information can be utilized, and the proposed information can be combined with each other.

According to at least one of the embodiments of the present disclosure, UE shall be able to achieve faster cell re-selection e.g., when in HPM or in flying mode. Taking intra-frequency cell re-selection for example, an example of shorter cell re-selection time achievable by the disclosure is given in Table 1.

TABLE 1

| DRX cycle | T_{detect, NR}_{_{—}}_{Intra} [s] (number of | | T_{measure, NR}_{_{—}}_{Intra} [s] (number of | | T_{evaluate, NR}_{_{—}}_{Intra} [s] (number of | |
|---|---|---|---|---|---|---|
| length [s] | DRX cycles) | | DRX cycles) | | DRX cycles) | |
| 0.32 | 2.56 × M2 | (8 × M2) | 0.32 × M3 | (1 × M3) | 0.96 × M4 | (3 × M4) |
| 0.64 | 5.12 | (8) | 0.64 | (1) | 1.92 | (3) |
| 1.28 | 8.96 | (7) | 1.28 | (1) | 3.84 | (3) |
| 2.56 | 10.24 | (4) | 2.56 | (1) | 7.68 | (3) |

Note 1:
when SMTC <= 40 ms, M2 = M3 = M4 = 1; and when SMTC > 40 ms, M2 = 1.5, M3 = M4 = 2
Note 2:
When [ATG-flag] is configured, the requirements apply only to UE supporting [ATG] is in [HPM].

Table 1 is an exemplary table 4.2.2.3-x: T_{detect, NR_Intra}, T_{measure, NR_Intra} and T_{evaluate, NR_Intra} for UE configured with [ATG-flag] (Frequency range FR1), which is based on Table 4.2.2.3-1: T_{detect, NR_Intra}, T_{measure, NR_Intra} and T_{evaluate, NR_Intra} in legacy non-high speed cell re-selection.

The cell re-selection time legacy non-high speed cell re-selection is given in Table 2 below.

TABLE 2

| DRX | | | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|---|
| cycle | Scaling Factor (N1) | | (number of DRX | (number of DRX | (number of DRX |
| length [s] | FR1 | FR2Note 1 | cycles) | cycles) | cycles) |
| 0.32 | 1 | 8 | 11.52*N1*M2 (36*N1*M2) | 1.28*N1*M2 (4*N1*M2) | 5.12*N1*M2 (16*N1*M2) |
| 0.64 | | 5 | 17.92*N1 (28*N1) | 1.28*N1 (2*N1) | 5.12*N1 (8*N1) |
| 1.28 | | 4 | 32*N1 (25*N1) | 1.28*N1 (1*N1) | 6.4*N1 (5*N1) |
| 2.56 | | 3 | 58.88*N1 (23*N1) | 2.56*N1 (1*N1) | 7.68*N1 (3*N1) |

Note 1:
Applies for UE supporting power class 2&3&4. For UE supporting power class 1 or 5, N1 = 8 for all DRX cycle length.
Note 2:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

It can be seen that according to one or more of the embodiments herein, the T_{detect, NR_Intra} in Table 1 could be smaller than legacy ones in Table 2.

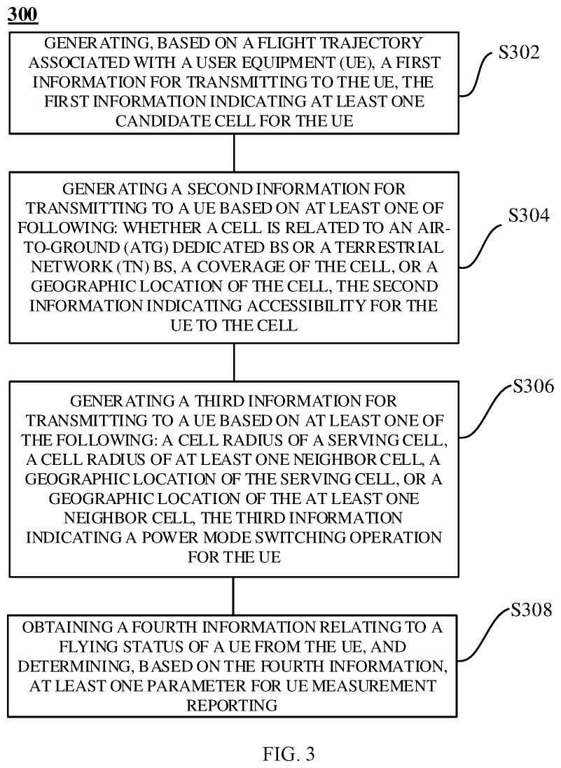

FIG. 3 illustrates a flowchart for an exemplary method for a network device in accordance with some embodiments. The method 300 illustrated in FIG. 3 may be implemented by the base station 150 described in FIG. 1. For example, the network device may be the network device of the base station 150.

In some embodiments, the method 300 for a network device may include performing at least one of the following steps: S302, generating, based on a flight trajectory associated with a user equipment (UE), a first information for transmitting to the UE, the first information indicating at least one candidate cell for the UE; S304, generating a second information for transmitting to a UE based on at least one of following: whether a cell is related to an Air-To-Ground (ATG) dedicated BS or a terrestrial network (TN) BS, a coverage of the cell, or a geographic location of the cell, the second information indicating accessibility for the UE to the cell; S306, generating a third information for transmitting to a UE based on at least one of the following: a cell radius of a serving cell, a cell radius of at least one neighbor cell, a geographic location of the serving cell, or a geographic location of the at least one neighbor cell, the third information indicating a power mode switching operation for the UE; and S308, obtaining a fourth information relating to a flying status of a UE from the UE, and determining, based on the fourth information, at least one parameter for UE measurement reporting.

In the following, each step of the method 300 will be described in details.

At step S302, a first information for transmitting to the UE is generated based on a flight trajectory associated with a user equipment (UE), the first information indicating at least one candidate cell for the UE.

In some embodiments, the first information includes a Physical Cell Identifier (PCI) list indicating at least one neighbor cell for the UE based on the flight trajectory.

In some embodiments, the first information further includes at least one geographic position for the at least one neighbor cell.

At step S304, a second information for transmitting to a UE is generated based on at least one of following: whether a cell is related to an Air-To-Ground (ATG) dedicated BS or a terrestrial network (TN) BS, a coverage of the cell, or a geographic location of the cell, the second information indicating accessibility for the UE to the cell.

In some embodiments, the second information includes a first indicator indicating whether the cell is suitable for Air-To-Ground (ATG) service. For example, the first indicator may be a Boolean parameter.

In some embodiments, the second information includes a first threshold for the cell to indicate that the cell is not suitable to a UE exceeding the first threshold, the first threshold including at least one threshold selected from a group consisting of a speed threshold and a height threshold.

At step S306, a third information for transmitting to a UE is generated based on at least one of the following: a cell radius of a serving cell, a cell radius of at least one neighbor cell, a geographic location of the serving cell, or a geographic location of the at least one neighbor cell, the third information indicating a power mode switching operation for the UE.

In some embodiments, the power mode switching operation includes to enter or to quit a specific power mode, the specific power mode including at least one of a high power mode or a low power mode. As already discussed above, the power mode switching operation may be under NW′ control by means of the third information, or the third information may be regarded as some axillary information, based on which the UE can determine whether to perform power mode switching.

In some examples, the third information includes a second indicator indicating the UE to enter or quit the specific power mode.

In some examples, the third information includes a second threshold for the UE to enter or quit the specific power mode upon satisfying the second threshold, the second threshold including at least one speed threshold, at least one height threshold, or both.

In some examples, the third information includes at least one of the following: a cell radius of a serving cell, at least one cell radius of at least one neighbor cell, a geographic location of the serving cell, or at least one geographic location of the at least one neighbor cell.

As already discussed above, the third information may include several indicators and/or thresholds for entering and quitting of HPM, LPM, and so on.

At step S308, obtaining a fourth information relating to a flying status of a UE from the UE, and determining, based on the fourth information, at least one parameter for UE measurement reporting.

In some embodiments, wherein the fourth information includes at least one of the following: a third indicator indicating whether the UE is flying; a moving speed of the UE; or an enumerated parameter indicating the moving speed of the UE. It can be understood that the fourth information may alternatively or additionally include other parameters or indicators, such as one for indicating a height or height level.

In some examples, the at least one parameter for UE measurement reporting include at least one of the following: a triggering threshold for Event A3, or a time-to-trigger (TTT) window.

Event A3 is triggered when a neighboring cell becomes better than the serving cell by an offset. The offset can be either positive or negative. By setting a smaller triggering threshold for Event A3, more sensitive handover can be achieved. As already discussed, in non-ATG scenarios, smaller A3 and/or shorter TTT window may cause unstable handover such as Ping-Pong HO, while in ATG scenarios, Ping-Pong HO are less likely to occur due to the characteristic of common flight trajectories. Therefore, it is beneficial to set differently based on flying or non-flying status of the UE.

Other benefits and advantageous technical effects are similar to those already described regarding to one or more methods on UE side, and is hereby omitted to avoid redundancy.

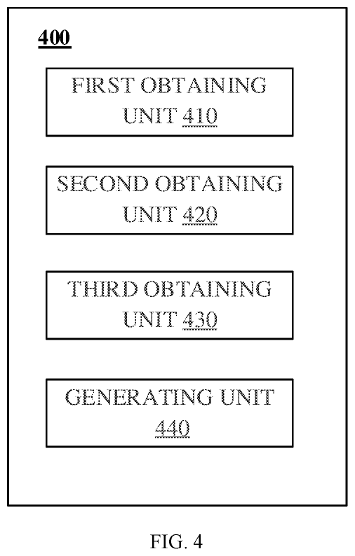

FIG. 4 illustrates an exemplary block diagram of an apparatus for a user equipment (UE) in accordance with some embodiments. The apparatus 400 illustrated in FIG. 4 may be used to implement the method 200 as illustrated in combination with FIG. 2.

As illustrated in FIG. 4, the apparatus 400 includes at least one of a first obtaining unit 410, a second obtaining unit 420, a third obtaining unit 430 and/or a generating unit 440.

The first obtaining unit 410 may be configured to obtain, from a base station (BS), a first information indicating at least one candidate cell, the first information being based on a flight trajectory associated with the UE.

The second obtaining unit 420 may be configured to obtain, from a BS, a second information indicating an accessibility of a cell, the second information being based on at least one of following: whether the cell is related to an Air-To-Ground (ATG) dedicated BS or a terrestrial network (TN) BS, a coverage of the cell, or a geographic location of the cell.

The third obtaining unit 430 may be configured to obtain, from a BS, a third information indicating a power mode switching operation, the third information being based on at least one of the following: a cell radius of a serving cell, a cell radius of at least one neighbor cell, a geographic location of the serving cell, or a geographic location of the at least one neighbor cell

The generating unit 440 may be configured to generate, based on a flying status of the UE and for a BS to determine at least one parameter for UE measurement reporting, a fourth information for transmitting to the BS.

According to the embodiments of the present application, cell re-selection procedure can be enhanced for ATG operation.

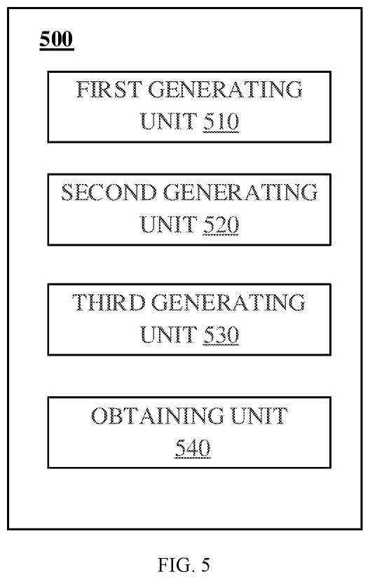

FIG. 5 illustrates an exemplary block diagram of an apparatus for a network in accordance with some embodiments. The apparatus 500 illustrated in FIG. 5 may be used to implement the method 300 as illustrated in combination with FIG. 3.

As illustrated in FIG. 5, the apparatus 500 includes at least one of a first generating unit 510, a second generating unit 520, a third generating unit 530, and an obtaining unit 540.

The first generating unit 510 may be configured to generate, based on a flight trajectory associated with a user equipment (UE), a first information for transmitting to the UE, the first information indicating at least one candidate cell for the UE.

The second generating unit 520 may be configured to generate a second information for transmitting to a UE based on at least one of following: whether a cell is related to an Air-To-Ground (ATG) dedicated BS or a terrestrial network (TN) BS, a coverage of the cell, or a geographic location of the cell, the second information indicating accessibility for the UE to the cell.

The third generating unit 530 may be configured to generate, a third information for transmitting to a UE based on at least one of the following: a cell radius of a serving cell, a cell radius of at least one neighbor cell, a geographic location of the serving cell, or a geographic location of the at least one neighbor cell, the third information indicating a power mode switching operation for the UE.

The obtaining unit 540 may be configured to obtain a fourth information relating to a flying status of a UE from the UE, and determining, based on the fourth information, at least one parameter for UE measurement reporting.

According to some embodiments of the present disclosure, cell re-selection procedure can be enhanced for ATG operation.

Also provided are an apparatus for a user equipment (UE) including one or more processors configured to perform steps of the method of one or more embodiments, an apparatus for a base station (BS) including one or more processors configured to perform steps of the method of one or more embodiments, a computer readable medium and a computer program product.

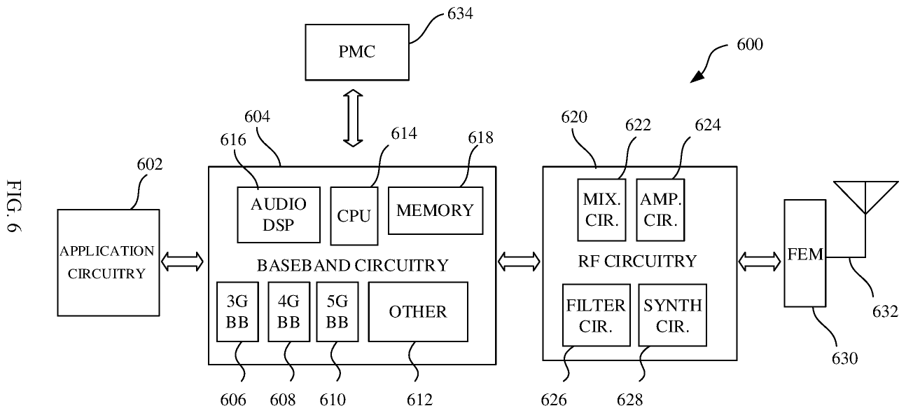

FIG. 6 illustrates example components of a device 600 in accordance with some embodiments. In some embodiments, the device 600 may include application circuitry 602, baseband circuitry 604, Radio Frequency (RF) circuitry (shown as RF circuitry 620), front-end module (FEM) circuitry (shown as FEM circuitry 630), one or more antennas 632, and power management circuitry (PMC) (shown as PMC 634) coupled together at least as shown. The components of the illustrated device 600 may be included in a UE or a RAN node. In some embodiments, the device 600 may include fewer elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 620 and to generate baseband signals for a transmit signal path of the RF circuitry 620. The baseband circuitry 604 may interface with the application circuitry 602 for generation and processing of the baseband signals and for controlling operations of the RF circuitry 620. For example, in some embodiments, the baseband circuitry 604 may include a third generation (3G) baseband processor (3G baseband processor 606), a fourth generation (4G) baseband processor (4G baseband processor 608), a fifth generation (5G) baseband processor (5G baseband processor 610), or other baseband processor(s) 612 for other existing generations, generations in development or to be developed in the future (e.g., second generation (2G), sixth generation (6G), etc.). The baseband circuitry 604 (e.g., one or more of baseband processors) may handle various radio control functions that enable communication with one or more radio networks via the RF circuitry 620. In other embodiments, some or all of the functionality of the illustrated baseband processors may be included in modules stored in the memory 618 and executed via a Central Processing ETnit (CPET 614). The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include a digital signal processor (DSP), such as one or more audio DSP(s) 616. The one or more audio DSP(s) 616 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 604 is configured to support radio communications of more than one wireless protocol may be referred to as multi-mode baseband circuitry.

The RF circuitry 620 may enable communication with wireless networks using modulated electromagnetic radiation through a non-solid medium. In various embodiments, the RF circuitry 620 may include switches, filters, amplifiers, etc. to facilitate the communication with the wireless network. The RF circuitry 620 may include a receive signal path which may include circuitry to down-convert RF signals received from the FEM circuitry 630 and provide baseband signals to the baseband circuitry 604. The RF circuitry 620 may also include a transmit signal path which may include circuitry to up-convert baseband signals provided by the baseband circuitry 604 and provide RF output signals to the FEM circuitry 630 for transmission.

In some embodiments, the receive signal path of the RF circuitry 620 may include mixer circuitry 622, amplifier circuitry 624 and filter circuitry 626. In some embodiments, the transmit signal path of the RF circuitry 620 may include filter circuitry 626 and mixer circuitry 622. The RF circuitry 620 may also include synthesizer circuitry 628 for synthesizing a frequency for use by the mixer circuitry 622 of the receive signal path and the transmit signal path. In some embodiments, the mixer circuitry 622 of the receive signal path may be configured to down-convert RF signals received from the FEM circuitry 630 based on the synthesized frequency provided by synthesizer circuitry 628. The amplifier circuitry 624 may be configured to amplify the down-converted signals and the filter circuitry 626 may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, the mixer circuitry 622 of the receive signal path may include passive mixers, although the scope of the embodiments is not limited in this respect.

In some embodiments, the mixer circuitry 622 of the transmit signal path may be configured to up-convert input baseband signals based on the synthesized frequency provided by the synthesizer circuitry 628 to generate RF output signals for the FEM circuitry 630. The baseband signals may be provided by the baseband circuitry 604 and may be filtered by the filter circuitry 626.

In some embodiments, the mixer circuitry 622 of the receive signal path and the mixer circuitry 622 of the transmit signal path may include two or more mixers and may be arranged for quadrature downconversion and upconversion, respectively. In some embodiments, the mixer circuitry 622 of the receive signal path and the mixer circuitry 622 of the transmit signal path may include two or more mixers and may be arranged for image rejection (e.g., Hartley image rejection). In some embodiments, the mixer circuitry 622 of the receive signal path and the mixer circuitry 622 may be arranged for direct downconversion and direct upconversion, respectively. In some embodiments, the mixer circuitry 622 of the receive signal path and the mixer circuitry 622 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 620 may include analog-to-digital converter (ADC) and digital-to-analog converter (DAC) circuitry and the baseband circuitry 604 may include a digital baseband interface to communicate with the RF circuitry 620.

In some dual-mode embodiments, a separate radio IC circuitry may be provided for processing signals for each spectrum, although the scope of the embodiments is not limited in this respect.

In some embodiments, the synthesizer circuitry 628 may be a fractional-N synthesizer or a fractional N/N+1 synthesizer, although the scope of the embodiments is not limited in this respect as other types of frequency synthesizers may be suitable. For example, synthesizer circuitry 628 may be a delta-sigma synthesizer, a frequency multiplier, or a synthesizer including a phase-locked loop with a frequency divider.

The synthesizer circuitry 628 may be configured to synthesize an output frequency for use by the mixer circuitry 622 of the RF circuitry 620 based on a frequency input and a divider control input. In some embodiments, the synthesizer circuitry 628 may be a fractional N/N+1 synthesizer.

In some embodiments, frequency input may be provided by a voltage controlled oscillator (VCO), although that is not a requirement. Divider control input may be provided by either the baseband circuitry 604 or the application circuitry 602 (such as an applications processor) depending on the desired output frequency. In some embodiments, a divider control input (e.g., N) may be determined from a look-up table based on a channel indicated by the application circuitry 602.

Synthesizer circuitry 628 of the RF circuitry 620 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 628 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 620 may include an IQ/polar converter.

The FEM circuitry 630 may include a receive signal path which may include circuitry configured to operate on RF signals received from one or more antennas 632, amplify the received signals and provide the amplified versions of the received signals to the RF circuitry 620 for further processing. The FEM circuitry 630 may also include a transmit signal path which may include circuitry configured to amplify signals for transmission provided by the RF circuitry 620 for transmission by one or more of the one or more antennas 632. In various embodiments, the amplification through the transmit or receive signal paths may be done solely in the RF circuitry 620, solely in the FEM circuitry 630, or in both the RF circuitry 620 and the FEM circuitry 630.

In some embodiments, the FEM circuitry 630 may include a TX/RX switch to switch between transmit mode and receive mode operation. The FEM circuitry 630 may include a receive signal path and a transmit signal path. The receive signal path of the FEM circuitry 630 may include an LNA to amplify received RF signals and provide the amplified received RF signals as an output (e.g., to the RF circuitry 620). The transmit signal path of the FEM circuitry 630 may include a power amplifier (PA) to amplify input RF signals (e.g., provided by the RF circuitry 620), and one or more filters to generate RF signals for subsequent transmission (e.g., by one or more of the one or more antennas 632).

In some embodiments, the PMC 634 may manage power provided to the baseband circuitry 604. In particular, the PMC 634 may control power-source selection, voltage scaling, battery charging, or DC-to-DC conversion. The PMC 634 may often be included when the device 600 is capable of being powered by a battery, for example, when the device 600 is included in an EGE. The PMC 634 may increase the power conversion efficiency while providing desirable implementation size and heat dissipation characteristics.

FIG. 6 shows the PMC 634 coupled only with the baseband circuitry 604. However, in other embodiments, the PMC 634 may be additionally or alternatively coupled with, and perform similar power management operations for, other components such as, but not limited to, the application circuitry 602, the RF circuitry 620, or the FEM circuitry 630.

In some embodiments, the PMC 634 may control, or otherwise be part of, various power saving mechanisms of the device 600. For example, if the device 600 is in an RRC Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used to execute Layer 3, Layer 2, or Layer 1 functionality, while processors of the application circuitry 602 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

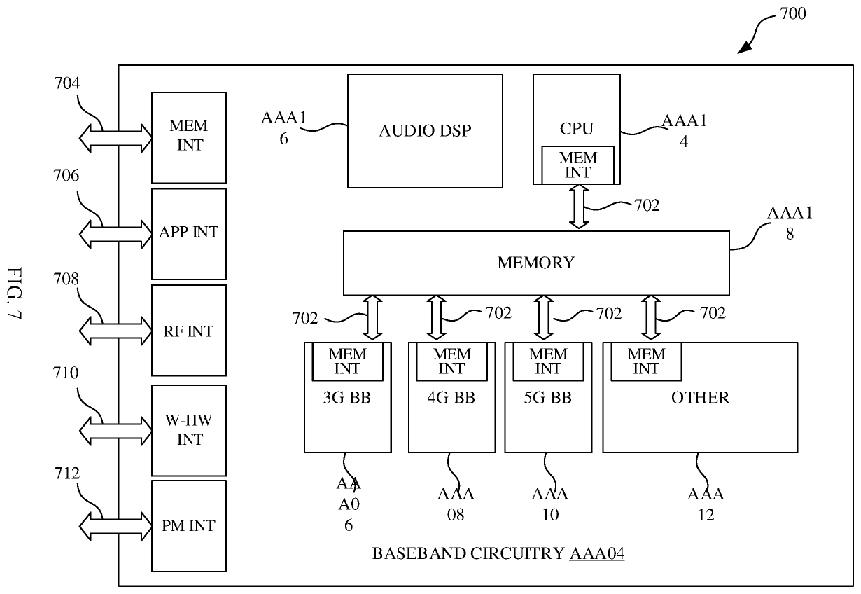

FIG. 7 illustrates example interfaces 700 of baseband circuitry in accordance with some embodiments. As discussed above, the baseband circuitry 604 of FIG. 6 may include 3G baseband processor 606, 4G baseband processor 608, 5G baseband processor 610, other baseband processor(s) 612, CPU 614, and a memory 618 utilized by said processors. As illustrated, each of the processors may include a respective memory interface 702 to send/receive data to/from the memory 618.

The baseband circuitry 704 may further include one or more interfaces to communicatively couple to other circuitries/devices, such as a memory interface 704 (e.g., an interface to send/receive data to/from memory external to the baseband circuitry 604), an application circuitry interface 706 (e.g., an interface to send/receive data to/from the application circuitry 602 of FIG. 6), an RF circuitry interface 708 (e.g., an interface to send/receive data to/from RF circuitry 620 of FIG. 6), a wireless hardware connectivity interface 710 (e.g., an interface to send/receive data to/from Near Field Communication (NFC) components, Bluetooth® components (e.g., Bluetooth® Low Energy), Wi-Fi® components, and other communication components), and a power management interface 712 (e.g., an interface to send/receive power or control signals to/from the PMC 634.

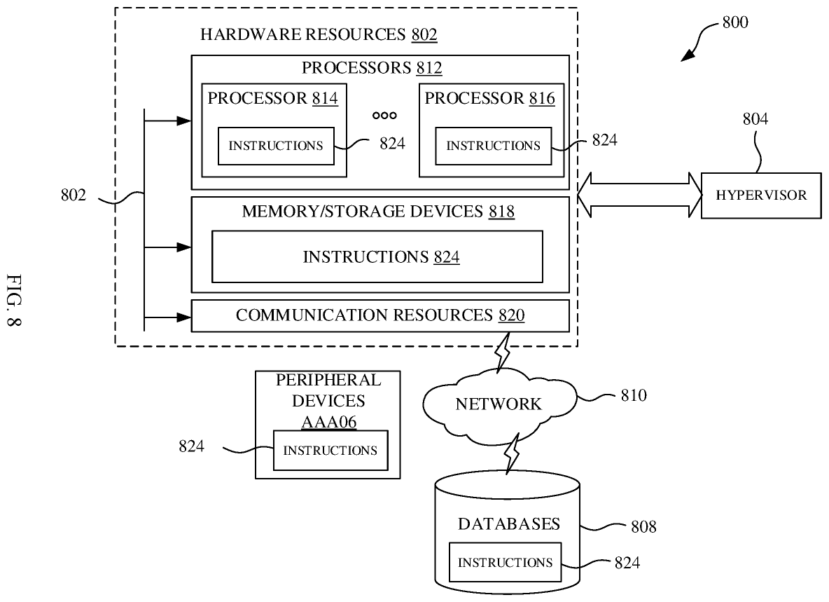

FIG. 8 is a block diagram illustrating components 800, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 802 including one or more processors 812 (or processor cores), one or more memory/storage devices 818, and one or more communication resources 820, each of which may be communicatively coupled via a bus 822. For embodiments where node virtualization (e.g., NFV) is utilized, a hypervisor 804 may be executed to provide an execution environment for one or more network slices/sub-slices to utilize the hardware resources 802.

The processors 812 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 814 and a processor 816.

The memory/storage devices 818 may include main memory, disk storage, or any suitable combination thereof. The memory/storage devices 818 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 820 may include interconnection or network interface components or other suitable devices to communicate with one or more peripheral devices 806 or one or more databases 808 via a network 810. For example, the communication resources 820 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 824 may include software, a program, an application, an applet, an app, or other executable code for causing at least any of the processors 812 to perform any one or more of the methodologies discussed herein. The instructions 824 may reside, completely or partially, within at least one of the processors 812 (e.g., within the processor's cache memory), the memory/storage devices 818, or any suitable combination thereof. Furthermore, any portion of the instructions 824 may be transferred to the hardware resources 802 from any combination of the peripheral devices 806 or the databases 808. Accordingly, the memory of the processors 812, the memory/storage devices 818, the peripheral devices 806, and the databases 808 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

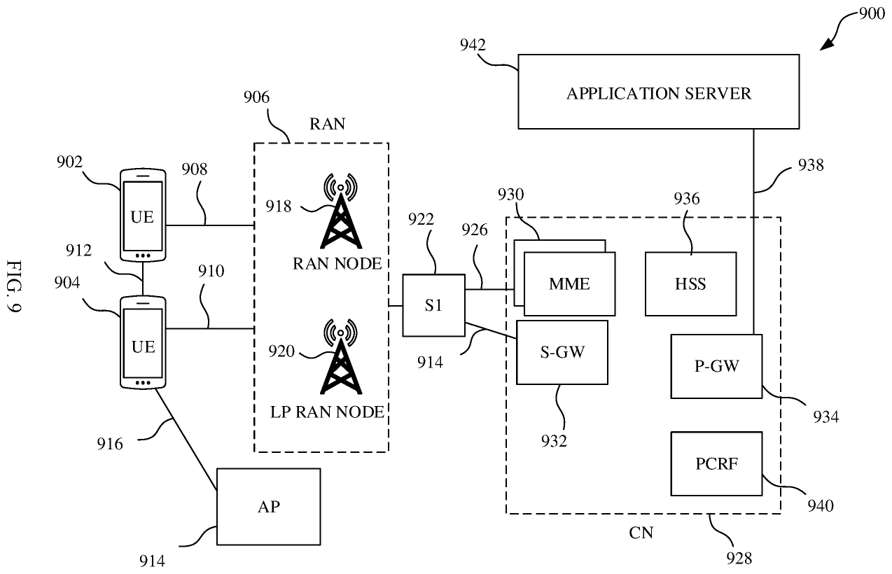

FIG. 9 illustrates an architecture of a system 900 of a network in accordance with some embodiments. The system 900 includes one or more user equipment (UE), shown in this example as a UE 902 and a UE 904. The UE 902 and the UE 904 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 902 and the UE 904 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 902 and the UE 904 may be configured to connect, e.g., communicatively couple, with a radio access network (RAN), shown as RAN 906. The RAN 906 may be, for example, an Evolved ETniversal Mobile Telecommunications System (ETMTS) Terrestrial Radio Access Network (E-UTRAN), a NextGen RAN (NG RAN), or some other type of RAN. The UE 902 and the UE 904 utilize connection 908 and connection 910, respectively, each of which includes a physical communications interface or layer (discussed in further detail below); in this example, the connection 908 and the connection 910 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 902 and the UE 904 may further directly exchange communication data via a ProSe interface 912. The ProSe interface 912 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 904 is shown to be configured to access an access point (AP), shown as AP 914, via connection 916. The connection 916 can include a local wireless connection, such as a connection consistent with any IEEE 802.11 protocol, wherein the AP 914 would include a wireless fidelity (WiFi®) router. In this example, the AP 914 may be connected to the Internet without connecting to the core network of the wireless system (described in further detail below).

The RAN 906 can include one or more access nodes that enable the connection 908 and the connection 910. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 906 may include one or more RAN nodes for providing macrocells, e.g., macro RAN node 918, and one or more RAN nodes for providing femtocells or picocells (e.g., cells having smaller coverage areas, smaller user capacity, or higher bandwidth compared to macrocells), e.g., a low power (LP) RAN node such as LP RAN node 920.

Any of the macro RAN node 918 and the LP RAN node 920 can terminate the air interface protocol and can be the first point of contact for the UE 902 and the UE 904. In some embodiments, any of the macro RAN node 918 and the LP RAN node 920 can fulfill various logical functions for the RAN 906 including, but not limited to, radio network controller (RNC) functions such as radio bearer management, uplink and downlink dynamic radio resource management and data packet scheduling, and mobility management.

In accordance with some embodiments, the EGE 902 and the EGE 904 can be configured to communicate using Orthogonal Frequency-Division Multiplexing (OFDM) communication signals with each other or with any of the macro RAN node 918 and the LP RAN node 920 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 918 and the LP RAN node 920 to the UE 902 and the UE 904, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 902 and the UE 904. The physical downlink control channel (PDCCH) may carry information about the transport format and resource allocations related to the PDSCH channel, among other things. It may also inform the UE 902 and the UE 904 about the transport format, resource allocation, and H-ARQ (Hybrid Automatic Repeat Request) information related to the uplink shared channel. Typically, downlink scheduling (assigning control and shared channel resource blocks to the UE 904 within a cell) may be performed at any of the macro RAN node 918 and the LP RAN node 920 based on channel quality information fed back from any of the UE 902 and UE 904. The downlink resource assignment information may be sent on the PDCCH used for (e.g., assigned to) each of the UE 902 and the UE 904.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 906 is communicatively coupled to a core network (CN), shown as CN 928—via an Sl interface 922. In embodiments, the CN 928 may be an evolved packet core (EPC) network, a NextGen Packet Core (NPC) network, or some other type of CN. In this embodiment the Sl interface 922 is split into two parts: the Sl-U interface 924, which carries traffic data between the macro RAN node 918 and the LP RAN node 920 and a serving gateway (S-GW), shown as S-GW 1132, and an Sl-mobility management entity (MME) interface, shown as Sl-MME interface 926, which is a signaling interface between the macro RAN node 918 and LP RAN node 920 and the MME(s) 930.

In this embodiment, the CN 928 includes the MME(s) 930, the S-GW 932, a Packet Data Network (PDN) Gateway (P-GW) (shown as P-GW 934), and a home subscriber server (HSS) (shown as HSS 936). The MME(s) 930 may be similar in function to the control plane of legacy Serving General Packet Radio Service (GPRS) Support Nodes (SGSN). The MME(s) 930 may manage mobility aspects in access such as gateway selection and tracking area list management. The HSS 936 may include a database for network users, including subscription-related information to support the network entities' handling of communication sessions. The CN 928 may include one or several HSS 936, depending on the number of mobile subscribers, on the capacity of the equipment, on the organization of the network, etc. For example, the HSS 936 can provide support for routing/roaming, authentication, authorization, naming/addressing resolution, location dependencies, etc.

The S-GW 932 may terminate the Sl interface 922 towards the RAN 906, and routes data packets between the RAN 906 and the CN 928. In addition, the S-GW 932 may be a local mobility anchor point for inter-RAN node handovers and also may provide an anchor for inter-3 GPP mobility. Other responsibilities may include lawful intercept, charging, and some policy enforcement.

The P-GW 934 may terminate an SGi interface toward a PDN. The P-GW 934 may route data packets between the CN 928 (e.g., an EPC network) and external networks such as a network including the application server 942 (alternatively referred to as application function (AF)) via an Internet Protocol (IP) interface (shown as IP communications interface 938). Generally, an application server 942 may be an element offering applications that use IP bearer resources with the core network (e.g., ETMTS Packet Services (PS) domain, LTE PS data services, etc.). In this embodiment, the P-GW 934 is shown to be communicatively coupled to an application server 942 via an IP communications interface 938. The application server 942 can also be configured to support one or more communication services (e.g., Voice-over-Internet Protocol (VOIP) sessions, PTT sessions, group communication sessions, social networking services, etc.) for the UE 902 and the UE 904 via the CN 928.

The P-GW 934 may further be a node for policy enforcement and charging data collection. A Policy and Charging Enforcement Function (PCRF) (shown as PCRF 940) is the policy and charging control element of the CN 928. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 940 may be communicatively coupled to the application server 942 via the P-GW 934. The application server 942 may signal the PCRF 940 to indicate a new service flow and select the appropriate Quality of Service (QoS) and charging parameters. The PCRF 940 may provision this rule into a Policy and Charging Enforcement Function (PCEF) (not shown) with the appropriate traffic flow template (TFT) and QoS class of identifier (QCI), which commences the QoS and charging as specified by the application server 942.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.
Example 1 is a method for a user equipment (UE), the method including:
   performing at least one of:
      obtaining, from a base station (BS), a first information indicating at least one candidate cell, the first information being based on a flight trajectory associated with the UE,
      obtaining, from a BS, a second information indicating an accessibility of a cell, the second information being based on at least one of following: whether the cell is related to an Air-To-Ground (ATG) dedicated BS or a terrestrial network (TN) BS, a coverage of the cell, or a geographic location of the cell,
      obtaining, from a BS, a third information indicating a power mode switching operation, the third information being based on at least one of the following: a cell radius of a serving cell, a cell radius of at least one neighbor cell, a geographic location of the serving cell, or a geographic location of the at least one neighbor cell, or
      generating, based on a flying status of the UE and for a BS to determine at least one parameter for UE measurement reporting, a fourth information for transmitting to the BS.
Example 2 is a method of Example 1, wherein the first information includes a Physical Cell Identifier (PCI) list based on the flight trajectory, and the method further including searching and measuring at least one neighbor cell in the PCI list.
Example 3 is a method of Example 2, wherein the first information further includes at least one geographic position for the at least one neighbor cell, and the method further including determining a start cell searching time based on the at least one geographic position and a location of the UE.
Example 4 is a method of Example 1, wherein the second information includes a first indicator indicating whether the cell is suitable for ATG service, and the method further including:
in response to determining that the UE is flying and that the cell is indicated in the first indicator as not suitable for ATG service, determining not to access or camp on the cell.
Example 5 is a method of Example 1, wherein the second information includes a first threshold for the cell, the first threshold including at least one threshold selected from a group consisting of a speed threshold and a height threshold, and the method further including:
in response to determining that the first threshold is exceeded for the UE, determining not to access or camp on the cell.
Example 6 is a method of Example 1, wherein the power mode switching operation includes to enter or to quit a specific power mode, the specific power mode including at least one of a high power mode or a low power mode, and
wherein the third information includes a second indicator indicating the UE to enter or quit the specific power mode, or
wherein the third information includes a second threshold including at least one speed threshold, at least one height threshold, or both, and the method further including determining to enter or quit the specific power mode upon satisfying the second threshold, or
wherein the third information includes at least one of the following: a cell radius of a serving cell, at least one cell radius of at least one neighbor cell, a geographic location of the serving cell, or at least one geographic location of the at least one neighbor cell, and the method further including determining to enter or quit the specific power mode based on the third information and at least one of the following: a moving speed, a height, or a location of the UE.
Example 7 is a method of Example 1, wherein the fourth information includes at least one of the following:
a third indicator indicating whether the UE is flying;
a moving speed of the UE; or
an enumerated parameter indicating the moving speed of the UE.
Example 8 is a method for a base station (BS), the method including:
performing at least one of:
generating, based on a flight trajectory associated with a user equipment (UE), a first information for transmitting to the UE, the first information indicating at least one candidate cell for the UE,
generating a second information for transmitting to a UE based on at least one of following: whether a cell is related to an Air-To-Ground (ATG) dedicated BS or a terrestrial network (TN) BS, a coverage of the cell, or a geographic location of the cell, the second information indicating accessibility for the UE to the cell,
generating a third information for transmitting to a UE based on at least one of the following: a cell radius of a serving cell, a cell radius of at least one neighbor cell, a geographic location of the serving cell, or a geographic location of the at least one neighbor cell, the third information indicating a power mode switching operation for the UE, or
obtaining a fourth information relating to a flying status of a UE from the UE, and determining, based on the fourth information, at least one parameter for UE measurement reporting.
Example 9 is a method of Example 8, wherein the first information includes a Physical Cell Identifier (PCI) list indicating at least one neighbor cell for the UE based on the flight trajectory.
Example 10 is a method of Example 9, wherein the first information further includes at least one geographic position for the at least one neighbor cell.
Example 11 is a method of Example 8, wherein the second information includes a first indicator indicating whether the cell is suitable for Air-To-Ground (ATG) service.
Example 12 is a method of Example 8, wherein the second information includes a first threshold for the cell to indicate that the cell is not suitable to a UE exceeding the first threshold, the first threshold including at least one threshold selected from a group consisting of a speed threshold and a height threshold.
Example 13 is a method of Example 8, wherein the power mode switching operation includes to enter or to quit a specific power mode, the specific power mode including at least one of a high power mode or a low power mode, and
wherein the third information includes a second indicator indicating the UE to enter or quit the specific power mode, or
wherein the third information includes a second threshold for the UE to enter or quit the specific power mode upon satisfying the second threshold, the second threshold including at least one speed threshold, at least one height threshold, or both, or
wherein the third information includes at least one of the following: a cell radius of a serving cell, at least one cell radius of at least one neighbor cell, a geographic location of the serving cell, or at least one geographic location of the at least one neighbor cell.
Example 14 is a method of Example 8, wherein the fourth information includes at least one of the following:
a third indicator indicating whether the UE is flying;
a moving speed of the UE; or
an enumerated parameter indicating the moving speed of the UE, and
wherein the at least one parameter for UE measurement reporting include at least one of the following: a triggering threshold for Event A3, or a time-to-trigger (TTT) window.
Example 15 is an apparatus for a user equipment (UE), the apparatus including: one or more processors configured to perform steps of the method according to any of Examples 1-7.
Example 16 is an apparatus for a base station (BS), the apparatus including: one or more processors configured to perform steps of the method according to Example 8-14.
Example 17 is an apparatus for a user equipment (UE), including means for performing steps of the method according to any of Examples 1-7.
Example 18 is an apparatus for a base station (BS), including means for performing steps of the method according to any of Examples 8-14.
Example 19 is a computer readable medium having computer programs stored thereon which, when executed by one or more processors, cause an apparatus to perform steps of the method according to any of Examples 1-7 or 8-14.
Example 20 is a computer program product including computer programs which, when executed by one or more processors, cause an apparatus to perform steps of the method according to any of Examples 1-7 or 8-14.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-20. (canceled)

21. A method comprising:
receiving, in a serving cell, air-to-ground (ATG) information for one or more neighbor cells associated with ATG access, wherein the ATG information includes respective physical cell identifiers (PCIs) of the one or more neighbor cells; and
performing cell re-selection, based on the ATG information, to select a target cell for ATG access.

22. The method of claim 21, wherein the ATG information is received via broadcast signaling.

23. The method of claim 21, wherein the ATG information includes location information for a base station associated with the target cell.

24. The method of claim 21, wherein the ATG information further includes height information for the target cell.

25. The method of claim 21, wherein the one or more neighbor cells for which the ATG information is received is based on a flight trajectory of a user equipment (UE).

26. The method of claim 21, further comprising receiving a system information block 1 (SIB1) with a field to indicate that ATG access is allowed in the target cell.

27. The method of claim 21, wherein the one or more neighbor cells are one or more first neighbor cells, and wherein the method further comprises:
receiving a system information block 1 (SIB1) associated with a second neighbor cell, wherein the SIBI includes a field to indicate that ATG access is not allowed in the second neighbor cell; and
excluding the second neighbor cell from consideration for the cell re-selection based on the indication that ATG access is not allowed.

28. The method of claim 21, wherein the cell re-selection is performed further based on a height or a speed of a user equipment (UE).

29. The method of claim 21, further comprising:
identifying that a user equipment (UE) is in a flying mode; and
generating, for transmission to a network, an indication that the UE is in the flying mode.

30. The method of claim 21, further comprising entering or leaving a high-power mode based on a cell radius or a cell location of the source cell or the one or more neighbor cells and a location, a height, or a speed of a user equipment (UE).

31. A method comprising:
determining a set of one or more neighbor cells for cell re-selection for air-to-ground (ATG) access; and
generating, for broadcast transmission in a serving cell, ATG information that indicates respective base station locations associated with the serving cell and the one or more neighbor cells.

32. The method of claim 31, wherein the ATG information further includes height information for the one or more neighbor cells.

33. The method of claim 31, further comprising determining the one or more neighbor cells in the set of one or more neighbor cells based on a flight trajectory of a user equipment (UE).

34. The method of claim 31, further comprising generating, for broadcast transmission in the serving cell, a system information block 1 (SIB1) with a field to indicate whether ATG access is allowed in the serving cell.

35. The method of claim 31, further comprising:
receiving, from a user equipment (UE), an indication that a UE is in a flying mode; and
configuring a measurement reporting event for the UE based on the indication.

36. An apparatus comprising:
processor circuitry to:
receive a first system information block (SIB) to indicate that air-to-ground (ATG) access is not allowed in a first cell;
receive a second SIB to indicate that ATG access is allowed in a second cell; and
perform cell re-selection to access the second cell based on the indication that ATG access is allowed in the second cell; and
interface circuitry coupled to the processor circuitry to enable communication.

37. The apparatus of claim 36, further comprising receiving, in the second cell, ATG information that indicates respective base station locations associated with the second cell and one or more neighbor cells.

38. The apparatus of claim 37, wherein the ATG information is received via broadcast signaling.

39. The apparatus of claim 37, wherein the one or more neighbor cells for which the ATG information is received is based on a flight trajectory of a user equipment (UE).

40. The apparatus of claim 37, wherein the processor circuitry is further to:
identify that a user equipment (UE) is in a flying mode; and
generate, for transmission to a network, an indication that the UE is in the flying mode.
